(19) United States
(12) Patent Application Publication
(10) Pub. No.: US 2024/0342648 A1
(43) Pub. Date: Oct. 17, 2024

(54) Gas Treatment Unit, Redox System and Method for Desulfurization of Gases Including Biogas

(71) Applicant: Streamline Innovations Inc., San Antonio, TX (US)

(72) Inventors: Peter J. Photos, Boerne, TX (US); Franklin Hailey Brown, II, San Antonio, TX (US); John C. Bourdon, Peculiar, MO (US); Cameron Nicolas Lee, San Antonio, TX (US); Billy G. Clark, Dallas, TX (US); Steven Bagley, Dallas, TX (US)

(73) Assignee: Streamline Innovations Inc, SAN ANTONIO, TX (US)

(21) Appl. No.: 18/752,056

(22) Filed: Jun. 24, 2024

Related U.S. Application Data
(63) Continuation of application No. 18/696,192, filed on Jan. 1, 0001.
(60) Provisional application No. 63/466,733, filed on May 16, 2023.
(60) Provisional application No. 63/401,374, filed on Aug. 26, 2022.

(51) Int. Cl. B01D 53/52

(52) U.S. Cl. CPC B01D 53/526; B01D 2251/90; B01D 2256/24; B01D 2257/304

(57) ABSTRACT

A gas treatment system configured to purify an influent gas stream including a hydrocarbon gas and a hydrogen sulfide gas comprises a reduction unit and an oxidation unit. The reduction unit includes at least one eductor configured to contact the influent gas stream with a primary stream including aqueous reducing reagent and release a purified hydrocarbon gas stream and a contacted primary stream including elemental sulfur. The oxidation unit includes at least one eductor configured to contact an oxidizing agent stream and a secondary stream including the primary stream and contacted primary stream and output a regenerated redox reagent stream.

### RELATED APPLICATION(S)

This is a Continuation application which claims priority to U.S. application Ser. No. 18/696,192 filed Mar. 27, 2024, which is a National Phase application which claims priority to PCT Application No. PCT/US23/73011 filed Aug. 28, 2023, which claims priority to U.S. Provisional Application No. 63/401,374 filed Aug. 26, 2022 and U.S. Provisional Application No. 63/466,733 filed May 16, 2023. The disclosures of the prior applications are incorporated herein by reference in their entirety.

### BACKGROUND OF THE DISCLOSURE

### 1. Field of the Disclosure

The present invention relates to a gas purification and processing system and method. More specifically, it relates to a gas treatment unit incorporated into a liquid reduction-oxidation (“redox”) system and method of using the gas treatment unit to purify gases (i.e., biogas, industrial waste gas, oil refining gases, etc.) through the removal hydrogen sulfide (“H₂S”) from the gas and generating elemental sulfur.

### 2. Description of the Related Art

Biogas is a renewable natural gas energy source that may be generated by organic decomposition in landfills as well as biodigesters or bioreactors designed for the anerobic digestion of organic material such as agriculture waste, plant materials, and food waste. Organic material may be placed in a bioreactor where anerobic digestion takes place. As digestion proceeds, biogas is produced and includes various components such as energy producing hydrocarbon gas including methane gas (“CH₃”) and a toxic H₂S gas contaminant. Before the CH₃ may be commercially transported or otherwise used for energy production, the H₂S must be removed.

Current systems and methods to remove or separate H₂S gas from the remaining energy producing gas were developed to treat natural gas and industrial/petroleum refining waste gases. For example, redox processes and amine systems are commonly used to remove H₂S from streams of natural gas as well as industrial and refining waste gases. Redox processes include reduction and oxidation steps. During the reduction step, the H₂S containing gas is contacted with a reagent that reduces H₂S, allowing solid sulfur to form and precipitate out of solution. Subsequently, in the oxidation step, the contacted and reduced reagent is oxidized back to its initial state.

For both the reduction and oxidation steps, conventional redox systems utilize tall column flow contactors such as co-counter flow bubble contactors, or strippers/scrubbers with or without media. During the reduction step, the H₂S containing gas is pressurized and/or forced through a tall column contactor, with or without media, as a reagent stream is gravity fed from a part of the column relatively higher than the gas is released into the tank. Likewise, during the oxidation step, the contacted reagent is fed into another tall column, with or without media. Additionally, a blower must be used to force an oxidizing stream such as ozone, enriched oxygen or atmospheric air through the tower.

When applied to biogas, the initial capital expenses and ongoing operational costs associated with the use of the conventional flow contactors (i.e., bubble columns and strippers, with or without media), are too high to render biogas an attractive, profitable source of renewable energy. This is due to the differing scales and characteristics of the biogas and natural gas sources. Processes developed for the natural gas treatment are designed to treat gas that is sourced from below the surface of the earth and therefore is under greater pressure than atmospheric pressure. As a result, natural gas may be produced at a pressure that allows the gas to move directly from the ground and into a bubble contactor or stripper without first being compressed. On the other hand, biogas is produced on the surface of the earth and near or standard pressure. Therefore, biogas would need to be compressed and/or blown before it can be treated in the conventional treatment unit (e.g., bubble column and/or air stripper). In either case, the initial capital cost and ongoing operational costs as well as required energy render this treatment option undesirable. Similarly, the energy and size of an amine system required to treat the gas renders the amine system impractical.

U.S. Pat. No. 4,525,338 entitled “Method for Removal of Hydrogen Sulfide” provides for a method of treating waste gas using redox, but this method includes many inefficiencies and is inapplicable to biogas. Initially, the waste gas is combined with dilution air. Then, the combined gas is sent through two eductors, connected in series, in which the gas is contacted with a reagent. The effluent of the first eductor is released into a first tank. The second eductor draws its influent from the first tank and then, discharges into a separate second tank. Next, the gas and reagent are sent to a bubble contactor which is a tall column that relies on a blower and forced air for operation and release of the treated gas stream including air from dilution and contacted gas. The use of the dilution air contaminates product stream for sale or energy production, while the blower for the oxidation air, bubble column countercurrent reactor increase costs, either capital or ongoing operational, as well introduce inefficiencies into the treatment of the waste gas. Further, the system cannot operate by receiving solely the waste gas and reagent but requires dilution air prior to the eductors and oxidation air for the bubble contactor.

Due to the many inefficiencies of the current technologies when applied to biogas, biogas is often flared and not used as an energy source. Therefore, there is a need for a method and system that may directly connect to a bioreactor or landfill, receive biogas and efficiently remove the H2S so biogas may be efficiently processed for energy generation.

### BRIEF SUMMARY OF THE DISCLOSURE

The invention of this disclosure provides an energy efficient and cost-effective system for desulfurization of biogas. Using eductors to contact the biogas with a redox reagent or reducing agent, the system may be directly connected to a biogas source such as a landfill or biogas generator to receive and treat the gas without any alteration in the flow characteristics. Therefore, compression or pumping of the biogas prior to system is not required. Further, the system may dropout elemental sulfur, via precipitation, from the biogas without diluting the biogas stream or using a tall column packed tower or scrubber with media.

In addition to biogas, the gas treatment unit, system and method of this disclosure are applicable to any hydrogen sulfide containing gas including industrially generated gases, gases generated by sewage treatment, and gases generated by decomposition of organic matter, etc.

In some aspects, the techniques described herein relate to a gas treatment system configured to treat an influent gas stream including hydrocarbon gas and a hydrogen sulfide gas, the system including: a reduction unit configured to contact the influent gas stream with a primary stream including an aqueous metal chelant and release a hydrocarbon gas stream separate from a contacted primary stream including elemental sulfur and a contacted aqueous metal chelant; and an oxidation unit including at least one oxidation eductor configured to contact an oxidizing gas stream and the contacted primary stream and output an oxidized stream including regenerated aqueous metal chelant.

In some aspects, the techniques described herein relate to a system, wherein the reduction unit further includes: at least one reduction eductor configured to contact the influent gas stream and the primary stream and output an eductor effluent stream including hydrocarbon gas, the contacted aqueous metal chelant and elemental sulfur; and a chamber downstream of the at least one reduction eductor, the chamber configured to receive the eductor effluent stream and release the hydrocarbon gas stream separate from the contacted primary stream including elemental sulfur and aqueous metal chelant.

In some aspects, the techniques described herein relate to a system, further including: a tank configured to hold the primary stream, receive the hydrocarbon gas stream from the reduction unit and release the hydrocarbon stream from the system.

In some aspects, the techniques described herein relate to a system, further including: a pump providing a motive force to the primary stream for operation of the oxidation eductor and reduction eductor.

In some aspects, the techniques described herein relate to a system, wherein the aqueous metal chelant further includes: metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a system, further including: a sulfur removal unit configured to separate the elemental sulfur from the primary stream.

In some aspects, the techniques described herein relate to a system, wherein the hydrocarbon gas includes methane, CO2 or any combination thereof.

In some aspects, the techniques described herein relate to a system, wherein the hydrocarbon gas is a biogas, a landfill generated gas, industrial waste gas, a petroleum or a gas refining waste gas, or any combination thereof.

In some aspects, the techniques described herein relate to a system, further including: a hydrocarbon gas generating unit connected upstream of the reduction unit, the hydrocarbon generator including a biogas generator, an anaerobic digestor, a landfill, a bio generator or any combination thereof.

In some aspects, the techniques described herein relate to a gas treatment system for contacting an influent gas stream including hydrogen sulfide and an aqueous reagent stream, the system including: a plurality of eductors configured to contact the influent gas stream with an aqueous reagent stream and release an eductor effluent stream including the gas and aqueous reagent streams; a chamber configured to receive the eductor effluent stream from the plurality of eductors, the chamber including a sidewall defining a treated gas outlet and an aqueous outlet, the chamber configured to separate the eductor effluent stream into a treated gas stream and contacted aqueous stream; at least one weir in the chamber, the at least one weir positioned between first and second eductors of the plurality of eductors, the at least one weir configured to allow flow under the at least one weir; and a first subchamber on one side of the at least one weir and a second subchamber on a second side of the at least one weir, the first and second subchamber in fluid communication by flow under the at least one weir.

In some aspects, the techniques described herein relate to a system further including: a second weir in the chamber, the second weir positioned between second and third eductors of the plurality of eductors, the second weir configured to allow flow under the second weir; and a third subchamber between the second weir and sidewall of the chamber and the second subchamber between the at least one weir and second weir, the first, second and third subchambers in fluid communication by flow under the first and second weirs.

In some aspects, the techniques described herein relate to a system, further including: a downcomer attached to a third outlet nozzle of the third eductor of the plurality of eductors, the downcomer extending into the third subchamber of the chamber.

In some aspects, the techniques described herein relate to a system, wherein the at least one weir includes perforations.

In some aspects, the techniques described herein relate to a system, wherein the at least one weir and the second weir include a recess in a lower edge under which the at least one weir allows fluid flow.

In some aspects, the techniques described herein relate to a system, further including: a polishing tank downstream of the chamber, the polishing tank including: a level of the aqueous reagent inside the polishing tank; a treated gas inlet including a downcomer including a slotted end, the slotted end extending into the polishing tank below the level of the aqueous reagent; and a polished gas outlet through which a polished gas stream is released from the polishing tank.

In some aspects, the techniques described herein relate to a system, wherein the aqueous reagent stream further includes: a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a method for continually removing hydrogen sulfide from an influent gas stream, the method including steps of: Contacting, via a reduction unit, the influent gas stream with a primary stream including an aqueous metal chelant and releasing a hydrocarbon gas stream separate from a contacted primary stream including elemental sulfur and contacted aqueous metal chelant; and contacting, via an oxidation eductor, an oxidizing gas stream and the contacted primary stream and releasing an oxidized stream including regenerated aqueous metal chelant.

In some aspects, the techniques described herein relate to a method, wherein the step of contacting the influent gas stream further includes steps of: contacting, via at least one reduction eductor, the influent gas stream and the primary stream and releasing an eductor effluent stream including hydrocarbon gas, contacted aqueous metal chelant and elemental sulfur; receiving, via a chamber downstream of the at least one reduction eductor, the eductor effluent stream; and releasing the hydrocarbon gas stream separate from the contacted primary stream including elemental sulfur and aqueous metal chelant.

In some aspects, the techniques described herein relate to a method, further including a step of: providing, via a pump, a motive force to the primary stream for operation of the oxidation eductor and the reduction eductor.

In some aspects, the techniques described herein relate to a method, wherein the step of contacting the influent gas stream with a primary stream including an aqueous metal chelant further includes the steps of: using metal chelants, ferric salts, ferrous salts, ferric chelants, ferrous chelants, nano-iron, colloidal iron, Fe-MGDA, HEME, organisms containing HEME, or any combination thereof.

In some aspects, the techniques described herein relate to a method, further including a step of: removing sulfur from the primary stream using a sulfur removal unit.

In some aspects, the techniques described herein relate to a method, wherein the influent gas stream includes hydrogen sulfide and methane, CO2, or any combination thereof.

In some aspects, the techniques described herein relate to a method, wherein the hydrocarbon gas is a biogas, a landfill generated gas, industrial waste gas, a petroleum or a gas refining waste gas, or any combination thereof.

In some aspects, the techniques described herein relate to a method, further including: connecting, upstream of the reduction unit, a hydrocarbon generator including a biogas generator, an anaerobic digestor, a landfill, a bio generator or any combination thereof.

In some aspects, the techniques described herein relate to a method, wherein the primary stream includes a metal chelant, metal chelants, ferric salts, ferrous salts, ferric chelants, ferrous chelants, nano-iron, colloidal iron Fe-MGDA, HEME, organisms containing HEME, or any combination thereof. ABSTRACT OF THE DISCLOSURE A gas treatment system configured to purify an influent gas stream including a hydrocarbon gas and a hydrogen sulfide gas includes a reduction unit and an oxidation unit. The reduction unit includes at least one eductor configured to contact the influent gas stream with a primary stream including aqueous reducing reagent and release a purified hydrocarbon gas stream and a contacted primary stream including elemental sulfur. The oxidation unit includes at least one eductor configured to contact an oxidizing agent stream and a secondary stream including the primary stream and contacted primary stream and output a regenerated redox reagent stream.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 depicts an example of an eductor, according to this disclosure;

FIG. 2 is schematic diagram of an embodiment, according to this disclosure, of a gas treatment system;

FIG. 3 is a flow diagram of a method, according to this disclosure. of using the gas treatment system of FIG. 2;

FIG. 4 is a flow diagram of a method, according to this disclosure, of making the gas treatment system depicted in FIG. 2.

FIG. 5 is a perspective view of an embodiment, according to this disclosure, of an eductor gas treatment unit;

FIG. 6 is the eductor gas treatment unit of FIG. 5 with the top and front side walls removed;

FIGS. 7 and 8 depict front views of internals of the eductor gas treatment unit of FIGS. 5 and 6;

FIG. 9 is a schematic of a second embodiment of a gas treatment system, according to this disclosure, incorporating the eductor gas treatment unit of FIG. 5;

FIG. 10 is a schematic of a third embodiment of a gas treatment system, according to this disclosure, incorporating the eductor gas treatment unit of FIG. 5;

FIG. 11 depicts a bubble column, according this disclosure, and incorporated into the gas treatment system of FIG. 10;

FIG. 12 is a flow diagram of a method of removing sulfur from a hydrogen sulfide containing gas using the unit and system of FIGS. 5, 9, and 10;

FIG. 13 is a flow diagram of the method of making the gas treatment unit of FIG. 5;

FIG. 14 is a flow diagram of a method making a polishing tank for the embodiment depicted in FIG. 9; and

FIG. 15 is a method, according to this disclosure, of making the system depicted in FIG. 10.

### DETAILED DESCRIPTION OF THE INVENTION

Certain terminology is used in the following description for convenience only and is not limiting. As used herein, the words “connected” or “coupled” are each intended to include integrally formed members, direct connections between two distinct members without any other members interposed therebetween and indirect connections between members in which one or more other members are interposed therebetween. The terminology includes the words specifically mentioned above, derivatives thereof, and words of similar import.

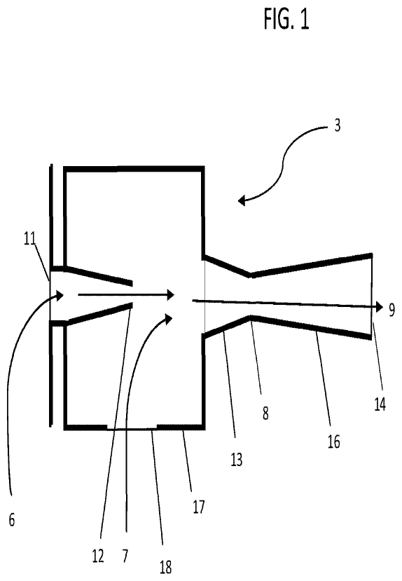

This disclosure includes multiple embodiments of efficient redox systems utilizing eductors 3 for both the reduction and oxidation operations. FIG. 1 depicts an example of an eductor 3, which includes a motive fluid inlet 11, an entrained fluid inlet 12, an outlet nozzle 14, a chamber 17, converging length 18, narrowing throat 8, and a diverging length. During operation, the narrowing throat 8 causes extreme turbulence due to the Venturi effect. As a result, the motive fluid 6 and inlet stream 7 are completely and thoroughly mixed to form the outlet stream 9. Depending on whether the eductor 3 is being used in an oxidation or reduction system, the motive fluid 6 and inlet stream 7 may be a gas or liquid with or without a solid suspended therein. During operation, the motive fluid 6 is pumped into the eductor 3 and entrains the inlet stream 7 into the eductor 3. Once inside the eductor 3, contacting between fluid 6 and stream 7 occurs in the chamber 17, converging length 18 and narrowing throat 8 causes such turbulence that the contacting continues through the diverging length 16 and beyond the outlet 14.

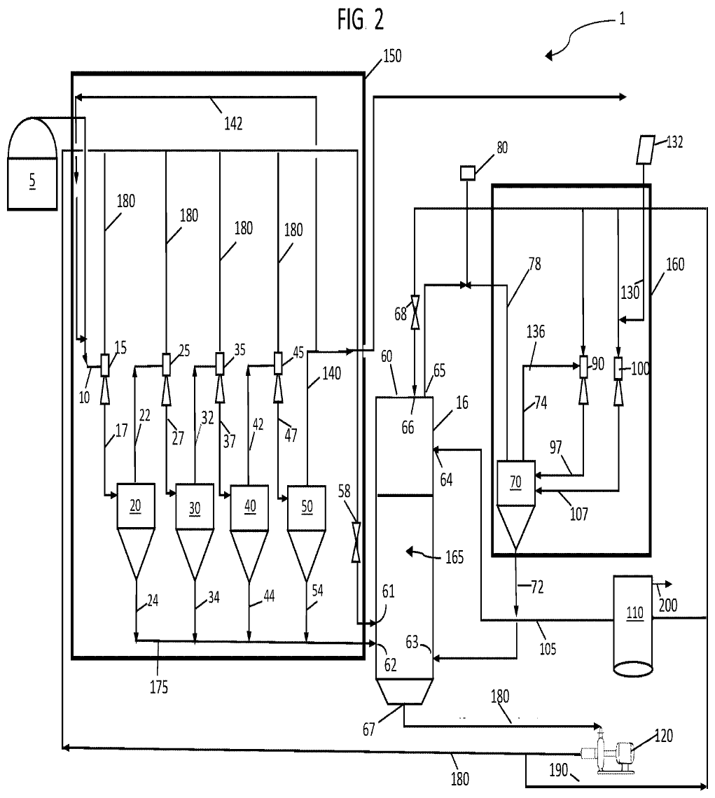

Each of the redox systems 1, 1200, 2200, according to this disclosure, utilize an aqueous redox reagent 165 (FIGS. 2, 9, 10) that is a reducing agent such as an aqueous metal chelant and may include one or more of ferric salts, ferrous salts, ferric chelants, ferrous chelants, nano-iron, colloidal iron, Fe-MGDA (ferric/ferrous methylglycinediacetate) such as Alanine, n,n-bid, (carboxymethyl) iron complex (CAS 547763-83-7), natural heme separated from natural organisms, whole organisms such as bacteria or yeast which include heme, and biosynthesized heme, etc. If the reagent 165 includes biosynthesized heme, a metallic porphyrin, such as iron porphyrins, may be preferred. Biosynthesized heme may be produced through recombinant DNA and genetic engineering of yeast. An example the biosynthesis of heme is described in U.S. Pat. Nos. 9,938,327 and 10,689,656 issued Apr. 10, 2018 and on Jun. 23, 2020, respectively, both of which are entitled “Expression Constructs and Methods of Genetically Engineering Methylotrophic Yeast”, and the contents of both applications are herein incorporated by reference in their entirety.

Reagent 165 is provided to each of the redox systems 1, 1200, 2200, according to this disclosure, via a corresponding primary stream 180, 1220, which is an aqueous stream including redox reagent 165. Suitable concentrations of iron, in any form discussed above, within streams 180, 1220 range from 4,000 mg/l to 20,000 mg/l. The concentration may be increased on decreased depending upon the concentration of the H₂S within stream 210, system performance and hydration.

Each treatment system 1, 1200, 2200 may receive an influent gas stream 10 directly from the hydrocarbon gas production unit 5 as a continual or segmented stream at standard temperature and pressure and/or without the need for compression or pumps to move the gas stream 10 into system 1. Additionally, system 1 may or may not include the hydrocarbon gas production unit 5. It is noted that the hydrocarbon gas production unit 5 may include many forms such as a bioreactor biogas generator, landfill, bio generator, anerobic digestor, industrial waste gas generator, petroleum refining waste gas generator, natural gas extraction unit, natural gas waste or any combination thereof.

Influent gas stream 10 may include energy producing hydrocarbons such as methane, H₂S and other gases, such as CO₂, in need of separation for use or transport. For example, the influent gas stream 10 may be a biogas stream from a biogenerator or landfill from which stream 10 may include H₂S and methane as well as other contaminants. It is noted that influent gas stream 10 may not include hydrocarbons, but may include H₂S and another fluid.

Referring now to the figures in detail, where like numbers are used to indicate like elements throughout, there is shown in FIG. 2 a redox treatment system 1 for purification of a hydrocarbon containing gas stream by treating hydrogen sulfide gas contained in a influent gas stream 10 and generating elemental sulfur. It is envisioned that system 1 may also be utilized to treat other hydrogen sulfide containing gases such as natural gas and industrial and petroleum refining waste gases. As shown in FIG. 1, the treatment system 1 may be directly connected to a bioreactor or hydrocarbon gas production unit 5 which generates a influent gas stream 10 including hydrogen sulfide gas. System 1 includes a reduction unit 150, an oxidation unit 160, a collection tank 60, a sulfur removal unit 110, influent gas stream 10, purified gas outlet stream 140, air inlet or vent 132, primary stream 180 and secondary stream 190.

The primary stream 180 and secondary stream 190 are configured, with the assistance of pump 120, to continually circulate a reagent 165 from tank 60 throughout system 1 and return the reagent 165 to tank 60. Pump 120 may be a centrifugal or vertical pump or any other suitable pump and may be positioned downstream of tank 60 so as to receive the primary stream 180 from the storage tank 60. Downstream of the pump 1130, the secondary stream 190 branches from the primary stream 180, and the secondary stream 190 represents a portion of the primary stream 180. While the primary stream 180 is influent to the reduction unit 150, one portion of the secondary stream 190 is influent to oxidation unit 160 and another portion of the secondary stream 190 is influent to the sulfur removal unit 110.

Tank 60 collects, stores and equalizes the reagent 165 for further circulation through the system 1. As such, the tank 60 may include a reservoir surrounded by a wall with multiple inlets and outlets including a bypass primary inlet 61, a contacted primary inlet 62, a secondary regenerated inlet 63, a desulfurized inlet 64, and a bypass secondary inlet 66, vent outlet 65 and primary stream outlet 67. The bypass primary inlet 61 may receive a portion of the primary stream 180 that bypassed treatment by the reduction unit 150. The contacted primary inlet 62 is configured to receive a portion of the primary stream 180 that is the effluent of reduction unit 150 which may include a liquid reagent and elemental sulfur at a relatively higher concentration than the reduction unit 150 influent primary stream 180. The secondary regenerated inlet 63 may receive a portion of secondary stream 190 that has been regenerated by the oxidation unit 160 while the bypass secondary inlet 66 may receive a portion of the secondary reagent stream 181 that bypasses the oxidation unit 160. Desulfurized inlet 64 allows the portion of the secondary stream 190 that has been desulfurized by the sulfur removal unit 110 to enter tank 60. Vent 65 allows the tank 60 to release air for pressure equalization. Outlet 67 allows the primary stream 180 to leave the tank 60 and flow to the pump 120 for circulation or recirculation through system 1.

Tank 60 receives streams 72, 105, 175, 180, 190 from the effluent of the reduction unit 150, oxidation unit 160 and sulfur removal unit 110, and each unit 150, 160, 110 may output varied concentrations of contacted reagent, regenerated reagent and elemental/solid sulfur. Therefore, in addition to storing the reagent 165, the tank serves as an equalization vessel for the mixing or combining of the streams 72, 105, 175 180, 190. As a result, the primary stream 180, leaving tank 60, may include solid sulfur, regenerated reagent, and contacted reagent, but the equalization within the tank 60 averages sulfur, contacted reagent and regenerated reagent concentration. As a result, the primary stream 180 includes an effective concentration of reagent 165 for contacting in the reduction unit 150.

The reduction unit 150 is configured to receive and contact an influent fluid containing hydrocarbons and H₂S and/or influent gas stream 10 with primary stream 180 and generate a purified hydrocarbon gas stream 140 as well as elemental sulfur. When the reagent 165 in the primary stream 180 contacts the H₂S in stream 10, the sulfide ions in the H₂S react combine to form elemental sulfur. For example, when an iron chelate is used as the reagent 165, a reaction occurs as follows:

Reduction: H₂S(g)+2Fe³⁺(aq)→2H⁺(aq)+S(s)+2Fe²⁺(aq).

As a result, the H₂S is removed from the influent stream 10 and a purified gas stream 140 is released to users. The purified gas stream 140 is a sweet gas stream which may be suitable for energy generation. It is noted that further preparation such as compression or other contaminant removal may be desired prior to use as an energy source.

To contact the influent gas stream 10 and primary stream 180, the reduction unit 150, according to this embodiment of the disclosure, may include at least one inlet or first eductor 15 or multiple eductors. In this embodiment of the disclosure, the reduction unit 150 has a plurality of eductors including inlet eductor 15, primary recirculation eductor 25, secondary recirculation eductor 35, and outlet eductor 45 connected in series with a corresponding collection chamber 20, 30, 40, 50 therebetween. The effluent of each eductor 15, 25, 35, 45 is an eductor effluent stream 17, 27, 37, 47, respectively, including a mixture of gas, liquid reagent and solid sulfur. Each collection chamber 20, 30, 40, 50 is configured to receive the corresponding stream 17, 27, 37, 47 and allow separation of the gas streams 22, 32, 42, 140 from a liquid stream including the solid sulfur suspended therein. Streams 22, 32, 42 are each received by the respective subsequent eductor 25, 35, 45. When the last collection chamber 50 separates the gas and liquid reagent, the collection chamber 50 releases the purified hydrocarbon stream 140.

Initially, inlet eductor 15 receives the primary stream 180, via pump 120 which is the motive force to pull the influent gas stream 10 inside the eductor 15 where streams 180 and 10 are contacted. In other words, pump 120 creates negative pressure or a vacuum to move the influent gas stream 10 into eductor 15. Then, the inlet eductor 15 outputs an inlet eductor stream 17 including a mixture of elemental or solid sulfur, gas and reagent. The first stream 17 is received by first collection chamber 20 and allows stream 17 to separate into a gas stream 22 and liquid stream 24.

Although gas stream 22 may contain significantly less H₂S than the influent stream 10, the H₂S concentration still may require treatment. To further eliminate hydrogen sulfide from gas stream 22, the remaining series of eductors 25, 35, 45 may be utilized. Processing in this series of the eductors 15, 25, 35, 45 may reduce the amount of H₂S in the gas streams in each step of the series. That is, the amount of H₂S containing gas in stream 10 may be greater than that of stream 22 which may be greater than stream 32 which may be greater than stream 42 which may be greater than stream 52 which may be a sweet gas stream. After contact in each eductor 15, 25, 35 and 45, the respective effluent streams 17, 27, 37 and 47 include a mixture of solid sulfur, gas and reagent. Each stream 17, 27, 37, 47 is received by a respective output chambers 20, 30, 40, 50. Each chamber 20, 30, 40, 50 has a gaseous output stream 22, 32, 42, 52, respectively. Streams 22, 32, and 42 may be treated in the corresponding, subsequent eductor 25, 35, and 45.

The effluent streams 24, 34, 44, and 54 of respective chambers 20, 30, 40, 50 may be returned to a branch stream 175 of the primary stream 180. The combination of streams 180, 24, 34, 44 and 54 are returned to tank 60 via inlet 62. It is noted that a portion of stream 180 may by pass the eductors 15, 25, 35 and 45 and return to the tank via inlet 61 which is controlled by valve 58.

After purified, gas stream 140 may include two branches with stream 140 routed to users and/or the next stage of processing for energy production and a recycled purified stream 142 branching from stream 140. Stream 142 circulates a portion of gas stream 140 to join the influent gas stream 10. A bioreactor or other hydrocarbon gas production unit 5 may not always provide a gas stream 10 with constant flow characteristics. Stream 142 assists with providing more consistent stream 10 flow.

The sulfur removal unit 110 receives a portion of the secondary stream 190 downstream of pump 120. A bag filter, filter press or other suitable sulfur removal apparatus including a settling tank, centrifuge, drying bed or any combination thereof, etc. may be used as sulfur removal unit 110. The effluent of the sulfur removal unit 110 includes desulfurized secondary stream 105 which may be a desulfurized liquid stream well as a solid sulfur stream 200.

The oxidation unit 160 is configured to regenerate the reagent 165 by contacting secondary stream 190 with an oxidizing stream 130. A suitable oxidizing stream 130 includes air, enriched oxygen, ozone or any combination thereof, etc. In this embodiment according to the disclosure, the oxidizing stream is air which is provided via vent 132.

The oxidation unit 160, according to this embodiment of the disclosure, includes at least one eductor 90, but preferably includes a pair of eductors 90, 100. Each eductor 90, 100 receives a portion of the secondary stream 190 from separate branches of stream 190. Stream 130 is connected to the inlet of eductor 100. Recycled air stream 136 is connected to the inlet of eductor 90 and includes the air separated from the effluent streams 107 and 97 from eductors 100 and 90, respectively. Within each eductor 90, 100 the reagent 165 in the secondary stream 190 mixes with the respective oxidizing stream 130,136 to regenerate the reagent 165. When contacted with the respective oxidizing stream 130, 136, a reaction occurs as follows

Oxidation: 2H⁺(aq)+2 Fe²⁺(aq)+0.5O₂(g)→2 Fe³⁺(aq)+H₂O(l).

Each eductor 90, 100 generates separate effluent streams 97 and 107, respectively, which are received by secondary chamber 70. The effluent streams 97 and 107 may include a mixture of the liquid reagent, oxidizing agent and elemental sulfur suspended therein. Within chamber 70, the effluent streams 97, 107 are combined and separated into two effluent streams including the regenerated secondary stream 72 and recirculation oxidizing stream 136. The regenerated secondary stream 72 may be conveyed to the tank 60 via inlet 63 while the oxidizing stream 136 runs from chamber 70 to the inlets of eductors 90, 100. Any of the oxidizing stream 130 that enters chamber 70 but does not become part of oxidizing stream 136 may be vented to the atmosphere via vent 80.

It is noted that the pressure of secondary stream 190 may be controlled by valve 68. Adjusting the pressure allows stream 190 to enter both eductors 90, 100 and the sulfur removal unit 110.

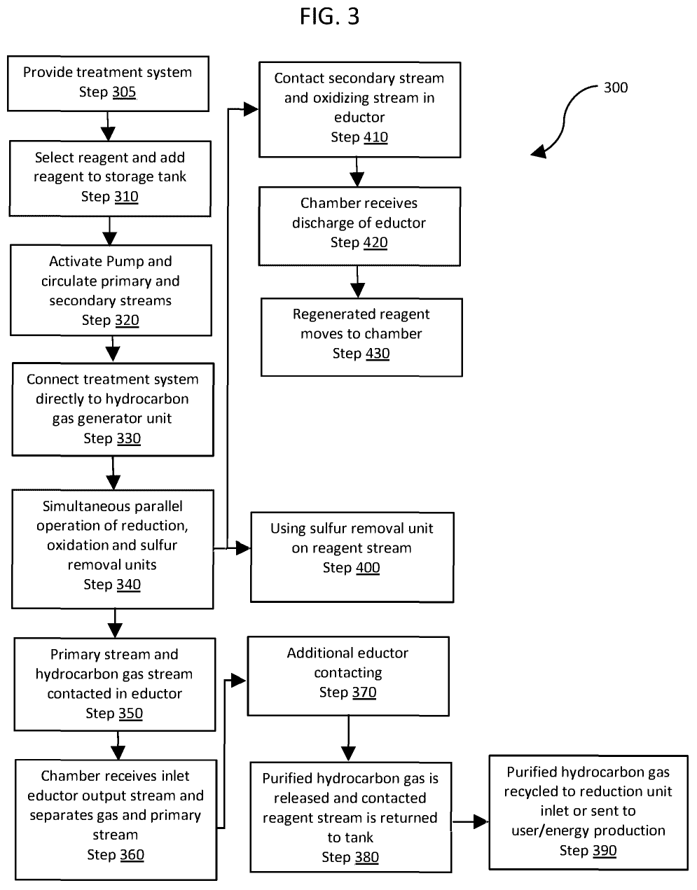

FIG. 3 depicts a flowchart of a method 300 of generating purified hydrocarbon gas and/or elemental sulfur according to this disclosure. In step 305, the treatment system 1 discussed above and depicted in FIG. 1 may be provided.

In step 310, the primary stream 180 may be initiated by adding a reducing or redox reagent 165 to the collection tank 60. Tank 60 is filled such that the volume of reagent added to the tank 60 is greater than the volume of reagent moving throughout the system 1 in streams 180 and 190 the oxidation unit 160 and reduction unit 150 at any point in time. A suitable reagent 165 may be selected from the examples provided above.

In step 320, pump 120 may be activated to begin to circulate the primary and secondary streams 180, 190 through system 1.

In step 330, influent gas stream 10, such as biogas or other hydrogen sulfide containing gas stream, is directly connected to system 1 at the inlet to the reduction unit 150. That is, one end of stream 10 may be connected directly to inlet eductor 15 while the other end of stream 10 is directly connected to the hydrocarbon gas generating unit 5 (i.e., bio generator or aerobic digester).

In step 340, as the primary stream 180 is pumped from the tank 60. secondary stream 190, as a portion of the primary stream, is also forced through the oxidation unit 160 and sulfur removal unit 110 and the entire system 1 is active. Therefore, step 340 includes the simultaneous and continual operation of the reduction unit 150, oxidation unit 160 and sulfur removal unit 110.

As streams 180, 190 are simultaneously circulated using one pump 120, only a portion of the secondary stream 190 is provided to the oxidation unit 160 and another portion of the secondary stream is provided to the sulfur removal unit 110. As a result, only a fraction of the reagent 165 that is contacted in the reduction unit 150 may be simultaneously regenerated in the oxidation unit 150. Similarly, only a fraction of the sulfur generated in the reduction unit 160 may be simultaneously removed via the sulfur removal unit 110.

In step 350, the hydrocarbon gas stream 10 is contacted with the primary stream 180. Initially, gas stream 10 is entrained into the reduction unit 150 by the pumping of stream 180 through inlet eductor 15. Within the first or inlet eductor 15, stream 180 contacts gas stream 10 and generates inlet eductor stream 17 which may include a mixture or solution of elemental or solid sulfur, gas and reagent.

In step 360, stream 17 is received by first chamber 20 which is configured to allow separation of the first stream 17 into a liquid stream 24 including the reagent and elemental sulfur and a contacted gas stream 22.

As discussed above, contact in the inlet eductor 15 may eliminate most of the H₂S gas from the influent gas stream 10. However, H₂S gas may still be present in inlet eductor stream 17. As a result, in step 370, stream 17 may be processed through one or more eductors 25, 35, 45 connected in series with the corresponding chambers 30, 40, 50 connected therebetween.

In step 380, the effluent gas stream of chamber 20, 30, 40, 50 corresponding the last eductor 15, 25, 35, 45 in series is released as a purified hydrocarbon gas stream 140 and the contacted primary stream 180 is returned to the storage tank 60 via stream 175. If as in the system 1 depicted in FIG. 2, there are four eductors 15, 25, 35, 45, then eductor 45 would be the last eductor and chamber 50 would be the corresponding chamber.

In step 390, a portion of the purified gas stream 140 released via conduit or stream 140 is conveyed for power generation or further removal of non-H₂S contaminants while another portion of purified gas stream 142 is recycled to the inlet conduit 10 where it may recirculate through the reduction unit 150 and contribute to the influent gas stream 10 to ensure there is adequate volume of gas flowing through the reduction unit 150. Thus, the recycled purified gas stream 142 makes up for times when the gas production unit may not be producing enough hydrocarbon gas to feed the inlet eductor 15.

Step 400 includes passing a portion of the secondary stream 190 through a sulfur removal unit 110 which may be a bag filter. Further, solid/elemental sulfur stream 200 is removed from system 1 and the desulfurized stream 72 is returned to tank 60.

Step 410 includes contacting the oxidizing stream 130 with the secondary stream 190 in reduction unit 160. Initially, an oxidizing stream 130 is entrained, via the pumping of secondary stream 190, in one or more than one eductor 90, 100 of the oxidation unit 160. In this example, the oxidizing agent in stream 130 is atmospheric air which is pulled into the eductor(s) 90, 100 through vent 132. Within the eductor(s) 90, 100, the stream 130 is contacted with the reagent stream 180, and the eductor(s) 90, 100 release eductor effluent stream(s) 97, 107.

In step 420, chamber 70 receives the oxidation eductor effluent stream(s) 97, 107 and separates the secondary stream 190 with regenerated reagent from any excess air or oxidizing agent.

In step 430, the secondary stream 190, via streams 97, 107, with regenerated reagent 165 is returned to the tank 60 and the oxidizing agent stream 136 is recycled to supplement the oxidizing stream 130 that is pulled through vent 132.

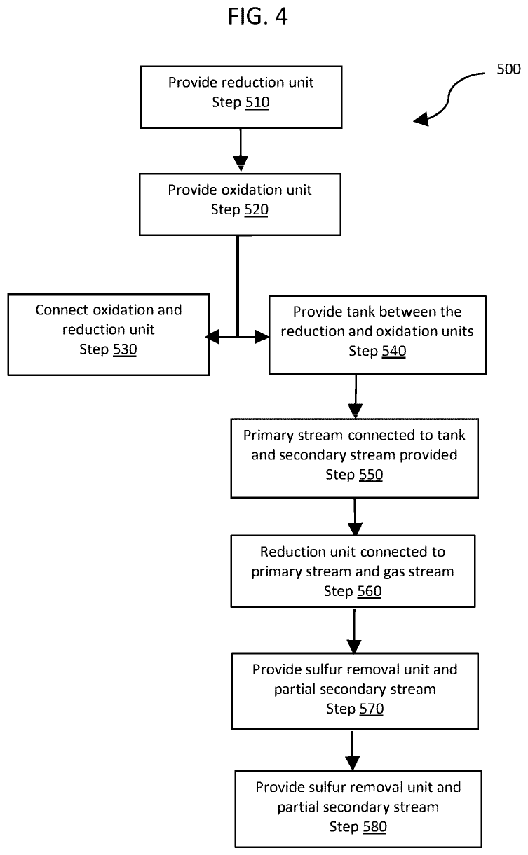

FIG. 4 depicts an embodiment, according to this disclosure, of method 500 for making system 1 to remove hydrogen sulfide from an influent gas stream 10. Initially, step 510, includes providing a reduction unit 150 configured to contact the influent gas stream 10 with a primary stream 180 including an aqueous reducing reagent 165 and release a purified gas stream 140 (i.e., purified hydrocarbon gas stream) and primary stream 175 including elemental sulfur and a contacted reducing reagent. As discussed above, the reduction unit 150 may include a first or inlet eductor 15 or a plurality of any number of eductors 15, 25, 35, 45. The eductors 15, 25, 35, 45 may be selected based on the influent flow rate of the gas stream 10. Also, nozzles may be placed on the inlets of the eductors 15, 25, 35, 45 to accommodate the flow of the primary stream 180.

The number of eductors 15, 25, 35, 45 in the system may be determined based on the concentration of H₂S in the influent gas stream 10 and the desired level of desulfurization. For example, the first eductor 15 may remove a significant portion of the H₂S from stream 10, and a number of subsequent eductors 25, 35, 45 may be used to polish the gas stream 10.

Step 520 includes providing an oxidation unit 160 including at least one eductor 100 configured to contact an oxidizing agent stream and a secondary stream 190 including the contacted reagent 165 and generate an oxidation eductor effluent stream 107 including regenerated reagent 165.

Step 530 includes connecting the oxidation unit 160 downstream of the reduction unit 150 such that the oxidation unit 160 receives stream 175 including the contacted reagent.

Alternatively, step 540, includes providing a collection tank 60 configured to receive the primary stream 180 including the contacted reagent stream 175 and secondary stream 190 including the regenerated reagent stream 72 and release the primary stream 180 including the regenerated reagent stream 72. The provided tank 60 may be configured as discussed above and should be large enough to allow for mixing and equalization of the primary stream 180, contacted reagent stream 175, regenerated reagent stream 72 and desulfurized stream 72.

In step 550, a primary stream 180 is provided from tank 60 and the secondary stream 190 is provided, as a branch of the primary stream 180, downstream of the tank. The secondary stream 190 may configured as a partial portion of the primary stream 180. As a result, the volumetric flowrate of the primary stream 180 moving through the reduction unit 150 would be greater than that of the secondary stream 190 moving through the oxidation unit 160.

In step 560, the reduction unit 150 may be connected to the primary stream 180 by connecting at least one eductor 15 to the primary stream 180. Further, a stream of gas 10 may be provided including a direct connection between unit 5 and eductor 15.

Step 570 includes providing the sulfur removal unit 110 configured to remove sulfur from a portion of the secondary stream 190. As such, a branch of the secondary stream 190 may be provided upstream or downstream of the oxidation unit 160. The branch of the secondary stream is configured to provide a partial portion of the secondary stream 190 to the oxidation unit 160 and another partial portion of the secondary stream 190 to the sulfur removal unit 110.

Further, the provided sulfur removal unit 110 may be configured to generate an elemental sulfur stream 200 and an effluent desulfurized secondary stream 105.

Step 580 includes connecting the desulfurized stream 105 between the sulfur removal unit 110 and tank 60 such that the desulfurized stream 105 may discharge into tank 60 via inlet 64.

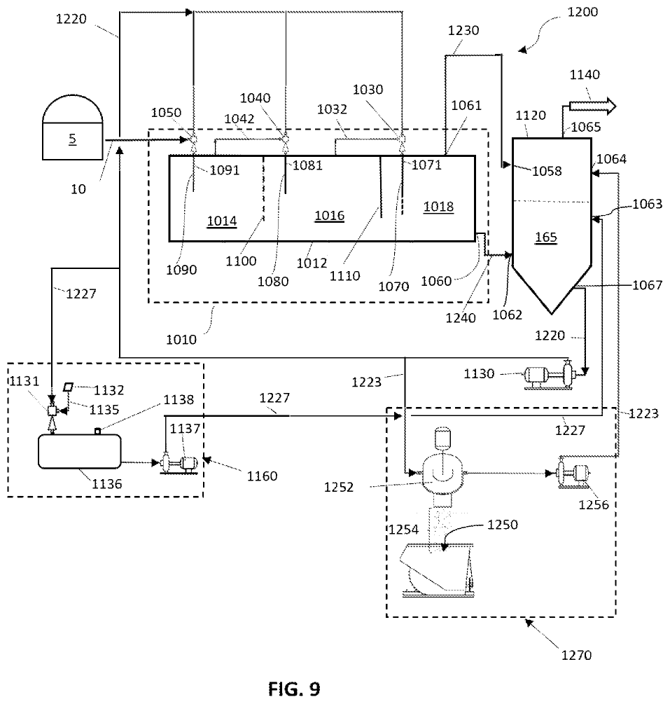

Referring now to FIG. 9, there is shown a second embodiment, according to this disclosure of gas treatment system 1200 for purification of a hydrocarbon containing influent gas stream 10 by treating hydrogen sulfide gas contained in a gas stream 10, such as a biogas stream, and generating elemental sulfur stream 1254. It is envisioned that system 1200 may also be utilized to treat other hydrogen sulfide containing gases from other generation sources such as natural gas and industrial and petroleum refining waste gases. As shown in FIG. 9, the treatment system 1200 may be directly connected to a hydrocarbon gas production unit 5 which generates influent gas stream 10 including hydrocarbons and hydrogen sulfide gas. The system 1200 includes a reduction unit 1010, an oxidation unit 1160, a collection tank 1120, a sulfur removal unit 1270, influent gas stream 10, purified effluent gas stream 1140, primary reagent stream 1220, secondary stream 1223, tertiary stream 1227, pump 1130, and redox reagent 165. Prior to desulfurization, stream 1223 is the secondary stream, but after desulfurization stream 1223 is the desulfurized secondary stream 1223. Also, prior to oxidation, stream 1227 is the tertiary stream and after oxidation, stream 1227 is the oxidized tertiary stream 1227.

The treatment system 1200 may continually receive influent gas stream 10 directly from the hydrocarbon gas production unit 5 without additional compression or pumps used to move the influent gas stream 10 into system 1200. Additionally, system 1200 may or may not include the hydrocarbon gas production unit 5. It is noted that the hydrocarbon gas production unit 5 may include many forms such as a bioreactor, biogas generator, landfill, bio generator, anerobic digestor, industrial waste gas generator, petroleum refining waste gas generator, natural gas extraction unit, or any combination thereof.

The primary stream 1220, secondary stream 1223, tertiary stream 1227, with the assistance of pump 1130, continually circulate a reagent 165 from tank 1120 throughout system 1200 and return the reagent 165 to tank 1120. Pump 1130 may be a centrifugal or vertical pump or any other suitable pump and may be positioned downstream of tank 1120 so as to receive the primary stream 1220 from tank 1120. Downstream of pump 1130, the secondary stream 1223 and tertiary stream 1227 branch from the primary stream 1220, and streams 1223, 1227 represent first and second portions, respectively, of the primary stream 1220. While the primary stream 1220 is influent to the reduction unit 1010, the tertiary stream 1227 is influent to oxidation unit 1160 and the secondary stream 1223 is influent to the sulfur removal unit 1270.

Tank 1120 collects, stores and equalizes reagent 165 for further circulation through system 1200. As such, the tank 1120 may include a reservoir surrounded by a wall with multiple inlets and outlets including a contacted primary reagent inlet 1062, a regenerated secondary inlet 1063, a desulfurized tertiary inlet 1064, and a purified gas stream outlet 1065 and primary stream outlet 1067. The contacted primary stream inlet 1062 is configured to receive the contacted primary stream 1240 which is a portion of the primary reagent stream 1220 that is the effluent of reduction unit 1010. The contacted primary stream 1240 may include a liquid reagent 165 and elemental sulfur at a relatively higher concentration than the primary stream 1220 that is influent to the reduction unit 1010. The secondary regenerated inlet 1063 may receive stream 1227, wherein the reagent 165, has been regenerated or oxidized by the oxidation unit 1160. Desulfurized inlet 1064 may receive stream 1223 that has been desulfurized by the sulfur removal unit 1270. Outlet 1065 allows tank 1120 to release the treated or gas stream which may be a hydrocarbon stream purified enough for use to generate energy or in need of further processing to remove other contaminants. Outlet 1067 allows the primary reagent stream 1220 to leave the tank 1120 and flow to the pump 1130 for circulation and/or recirculation through the system 1200.

Tank 1120 receives streams 1220, 1223 and 1227 from the effluent of the reduction unit 1010, oxidation unit 1160 and sulfur removal unit 1270, and each unit 1010, 1160, 1270 may output corresponding streams 1220, 1223 and 1227 including varied concentrations of contacted, regenerated or unused reagent 165 and/or elemental/solid sulfur. Therefore, in addition to storing the reagent 165, tank 1120 serves as an equalization vessel for the mixing or combining of streams 1220, 1223, 1227. As a result, the primary stream 1220, leaving tank 1120, may include solid sulfur, contacted, regenerated or unused reagent 165, but the equalization within the tank 1120 may average the sulfur, contacted reagent and regenerated reagent concentration. As a result, the primary stream 1220 includes an effective concentration of reagent 165 for contacting in the reduction unit 1010.

The reduction unit 1010 is configured to receive and contact an influent fluid or influent gas stream 10 including H₂S and hydrocarbons such as biogas with primary stream 1220 and generate a purified or treated hydrocarbon effluent gas stream 1140 as well as elemental sulfur. When the primary stream 1220 contacts the H₂S in stream 10, the reagent 165 reacts with the H₂S and sulfide ions combine to form elemental sulfur. For example, if the reagent 165 is an iron chelant, the reduction reaction provided above occurs. As a result, the H₂S is removed from the influent gas stream 10 and a purified gas stream 1140 is released to users. The purified gas stream 1140 is a sweet gas stream which may be suitable for energy generation. It is noted that further preparation such as compression or other contaminant removal may be desired prior to use as an energy source.

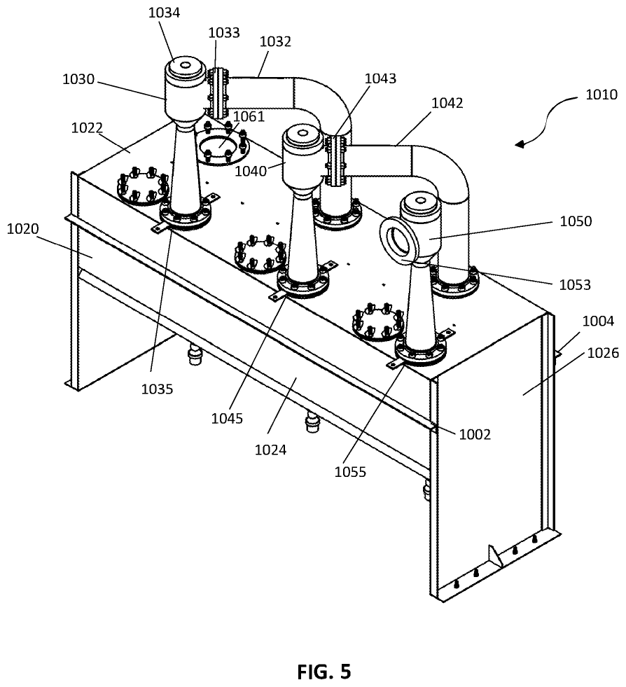

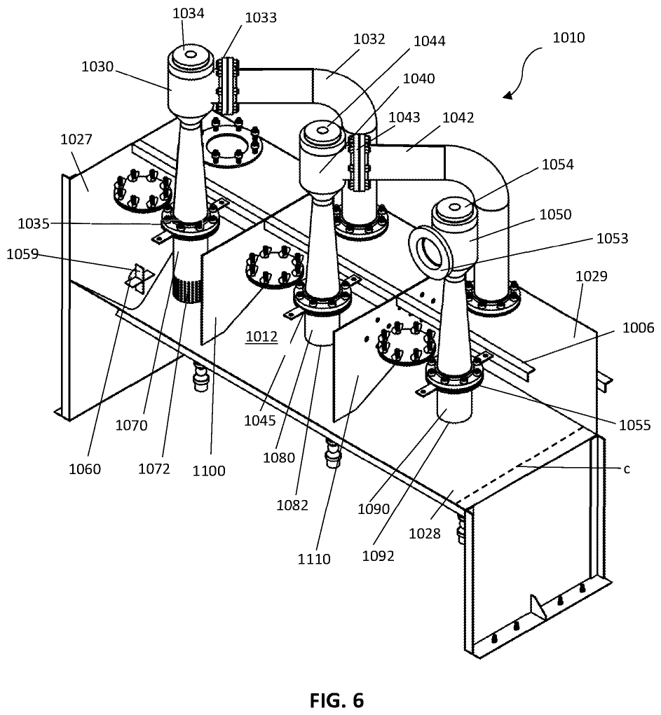

To contact the influent gas stream 10 and primary stream 1220, the reduction unit 1010, according to this embodiment of the disclosure, as shown in FIGS. 5 and 6 may utilized. Unit 1010 includes a chamber 1012, first eductor 1050, second eductor 1040 and third eductor 1030, a first weir 1100, second weir 1110, first downcomer 1090, second downcomer 1080, third downcomer 1070, a purified or treated gas outlet 1061 and an aqueous outlet 1060. It is noted that the concentration of H₂S in the influent gas stream 1210 may be reduced with at least one eductor 1050 and the additional eductors 1040, 1030 may be included for further reduction in H₂S concentrations.

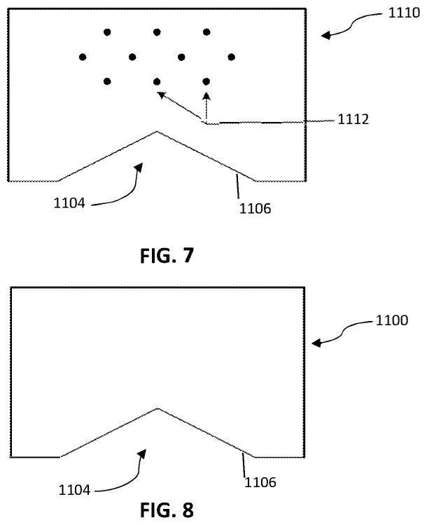

Chamber 1012 is hollow and defined by sidewall 1020 which includes sidewalls 1026, 1027, upper sidewall 1022, bottom sidewall 1028, front sidewall 1024 and rear sidewall 1029. The upper sidewall 1022 includes openings correspond to the attachment of eductor or contacted fluid nozzle outlets 1035, 1045 and 1055 of the eductors 1030, 1040 and 1050, respectively. FIG. 6 depicts chamber 1012 without the front sidewall 1024 and upper sidewall 1022. The first or solid weir 1100 (FIG. 7) is positioned between the second and third eductors 1030, 1040. The second or perforated weir 1110 (FIG. 8) is positioned between the first and second eductors 1050, 1040. The weirs 1100, 1110 are spaced apart such that the chamber is divided into subchambers 1014, 1016, 1018.

As shown in FIGS. 6, 7 and 8, both the first and second weirs 1100, 1110 extend from the front sidewall 1024 to the rear sidewall 1029 and from the upper sidewall 1022 towards the bottom sidewall 1028. While the weirs 1100, 1110 may abut sidewalls 1022, 1024, 1029, each weir 1100, 1110 may be spaced apart from the bottom sidewall 1028. Further, each weir may include a recess 1104 in the lower edge 1106 of the weir 1100, 1000 facing bottom sidewall 1028. The space between each weir 1100, 1110 and the bottom sidewall 1028, allows subchambers 1014, 1016, 1018 to be in fluid communication with the reagent stream being permitted to freely flow from between the chambers in a downstream or upstream manner. Also, this use of the weirs 1100, 1110 within chamber 1012 permits the depth of aqueous reagent 165 to equalize within chamber 1012. Further equalization of the fluid level within the chamber is accomplished by perforations 1112, which are through holes, in second weir 1110. The use of the V-notch recess 1104 assists with the control of gas flow between subchambers 1014, 1016, 1018. It is noted that recess 1104 is shown as a V-notch in FIGS. 7 and 8, but other shapes such as semi-circles and semi-ellipses may be used.

The first, second and third eductors 1050, 1040, 1030 include the narrowing throat 8 as well as a corresponding entrained fluid of gas inlets 1053, 1043, 1033, motive fluid or aqueous inlets 1054, 1044, 1034 and a eductor or contacted fluid nozzle outlets 1055, 1045, 1035. Each aqueous inlet 1054, 1044, 1034 of the eductors 1050, 1040, 1030 is connected to the primary stream 1220 which is transferred, via pump 1130, from tank 1120. The first inlet 1053 of the first eductor is connected to the influent gas stream 1210. The second inlet 1044 of the second eductor 1040 is connected to conduit or stream 1042 which is an intake from the fluid within subchamber 1014. The third inlet 1034 of the third eductor 1030 is connected to conduit or stream 1032 which is an intake from the fluid within subchamber 1016.

Within each eductor 1050, 1040, 1030 the primary reagent stream 1220, including the reactant 165, contacts the corresponding influent gas stream 1210, 1032, 1042. Pump 1130 provides the motive force to the primary stream 1220 (i.e., motive fluid 6) which entrains the corresponding influent gas stream 1210, 1032, 1042. Within the first eductor 1050, the influent gas stream 1210 is contacted by the primary stream 1220, and the first eductor discharges a first eductor stream 1091, via downcomer 1090 to subchamber 1014. The first eductor stream 1091 includes a mixture of elemental or solid sulfur, gas and reagent 165. Inside the second eductor 1040, stream 1032, which originates from subchamber 1014, is contacted by primary stream 220, and the second eductor 1040 discharges a second eductor stream 1081, via downcomer 1080 to subchamber 1016. The second eductor outlet stream 1081 also includes a mixture of elemental or solid sulfur, gas and reagent 165. Inside the third eductor 1030, stream 1032, which originates from subchamber 1016, is contacted by primary stream 1220, and the third eductor 1030 discharges a third eductor stream 1071, via downcomer 1070 to subchamber 1018. The third eductor outlet stream 1071 also includes a mixture of elemental or solid sulfur, gas and reagent 165. Due to the contacting within eductors 1030, 1040, 1050, the reagent 165 in streams 1071, 1081, 1091 may be contacted and non-contacted reagent 165. The first downcomer 1090, second downcomer 1080 and third downcomer 1070 are connected to corresponding outlets 1055, 1045, 1035 of the corresponding eductors 1050, 1040, 1030. Downcomer 1070 includes a length sufficient to extend below the level of the fluid within tank 1120. Further, the third downcomer 1070 includes a slotted end 1072 which promotes gas dispersion to improve H₂S going into solution and treating gas stream 1210 to specification.—

Treated gas outlet 1061 and aqueous outlet 1060 are positioned in the sidewall 1020 of subchamber 1018. The gas outlet 1061 may be positioned at a relatively higher portion of the sidewall 1020 than the aqueous outlet 1060. As shown in FIG. 9, gas outlet 1061 is defined by the upper sidewall 1022, and aqueous outlet 1060 is defined by the sidewall 1027. Further, the aqueous outlet 1060 may include a flow device 1059 (FIG. 6) which inhibits vortexing and gas carryunder.

Although each eductor outlet stream 1071, 1081, 1091 includes a mixture of elemental or solid sulfur, gas and contacted and non-contacted reagent 165, the ratios of H₂S gas, solid sulfur to contacted or available reagent 165 changes in each stream 1071, 1081, 1091. Although the first eductor outlet stream 1091 may contain significantly less H₂S than the influent gas stream 1210, the H₂S concentration still may require treatment for safe use in energy production or transport. To further eliminate hydrogen sulfide from gas stream 1210, processing through the remaining second and third eductors 1040, 1030 may be performed. Due the use of multiple eductors, the control of the flow into the chamber 1012, via downcomers 1090, 1080, 1070, as well as an iron or metal chelant concentration of about 10,000 mg/l, the H₂S concentration of the purified effluent gas stream 1140, released via gas outlet 1061, may be reduced to 4 ppmv or below.

That is, the amount of H₂S contained in stream 1210 may be greater than that of stream 1091 which may be greater than stream 1081 which may be greater than stream 1071, and treated gas stream 1140, the last of which may be a sweet gas stream suitable for transport and/or use.

The treated gas stream 1230 exits subchamber 1018 through outlet 1061. Next, stream 1230 enters tank 1120 via inlet 1058. Gas outlet 1065, then, allows treated gas stream 1140 to exit the tank 1120.

The sulfur removal unit 1270 receives a secondary reagent stream 1223, which branches from stream 1220, downstream of pump 1130. As shown in FIG. 9, sulfur removal unit 1270 includes a pump 1256 and centrifuge 1252 which releases solid sulfur stream 1254 into a bin or rollaway 1250. Instead of or in addition to the centrifuge 1252 other suitable separation apparatus may be utilized including a bag filter, filter press, settling tank, drying bed or any combination thereof. The aqueous effluent of the sulfur removal unit 1270 includes desulfurized secondary stream 1223 which is returned, via pump 1256, to the tank 1120 for recirculation within the system 1200.

The oxidation unit 1160 is configured to regenerate the contacted reagent 165 by contacting tertiary stream 1227, which branches from stream 1220 downstream of pump 1130, with an oxidizing stream 1135. A suitable oxidizing stream 130 includes air, oxygen, ozone or any combination thereof, etc. In this embodiment according to the disclosure, the oxidizing stream 1135 is air which is provided via vent 1132.

The oxidation unit 1160, according to this embodiment of the disclosure, includes at least one oxidation eductor 1131, oxidation stream 1135, air vent 1132, oxidation tank 1136 and pump 1137, but may include additional eductors as necessary. Eductor 1131 is a Venturi eductor and receives the tertiary stream 1227 and air stream 1135. Pump 1130 is the motive force for moving the tertiary stream 1227 through eductor 1131 and pulling the air stream 1135 from the atmosphere via vent 1132. Within eductor 1131, streams 1227 and 1135 are entrained and the contact of streams 1227, 1135 results in the regeneration of contacted reagent 165 within stream 1227. The effluent of eductor 1131 is discharged into tank 1136 which includes a vent 1138 to release the unused portion of the oxidation stream 1135 to the atmosphere. Pump 1137 forces the oxidized tertiary stream including the regenerated reagent 165 to the tank 1120.

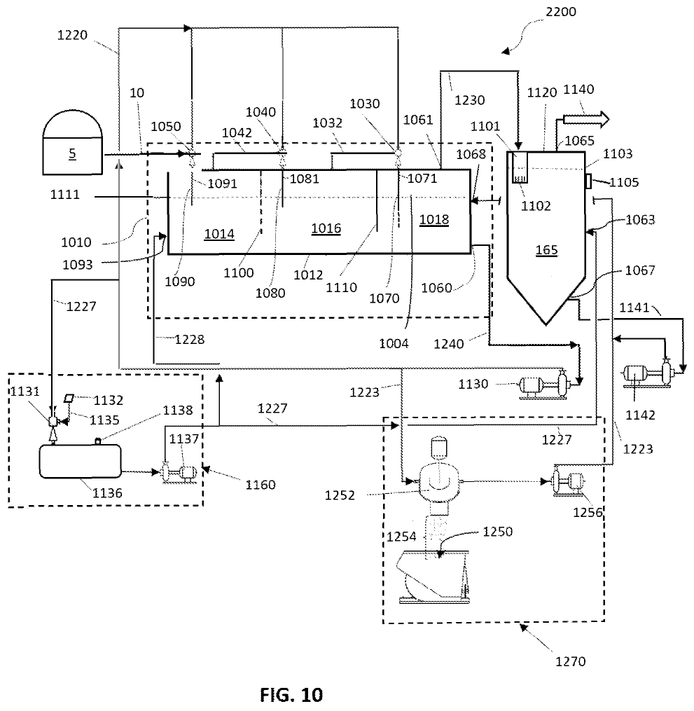

When additional polishing or removal of H₂S from the influent gas stream 1210 may be necessary, gas treatment system 2200, which includes modifications of system 1200 and is a third embodiment according to this disclosure, may be utilized. As shown in FIG. 10, system 2200 includes additional pump 1142 and tank 1120 includes a downcomer 1101 with a slotted end 1102. Further, chamber 1012 includes additional inlets 1093 and 1068 which allow streams 1228 and 1141 to enter subchambers 1014 and 1018, respectively.

Tank 1120 includes outlet 1067 which directs stream 1141 to pump 1142 which redirects stream 1141 upstream to inlet 1068 through which stream 1141 enters subchamber 1018. In other words, stream 1141 represents a countercurrent flow of reagent 165 while the effluent of subchamber 1018, stream 1240, proceeds to pump 1130 which then pumps primary stream 1220 throughout system 2200.

Stream 1230, in this embodiment, enters tank 1120 through downcomer 1101. Preferably, the downcomer includes a slotted end 1102 which extends below the level of the primary stream 1220 in tank 1120. As the treated gas stream 1230 flows into tank 1120 via the slotted downcomer 1101 the gas stream 1230 bubbles through the primary stream 1220 which includes available reagent 165. Therefore, additional removal of H₂S (i.e., polishing) occurs. Next, the purified gas stream 1140 is released from tank 1120 for use in energy generation and/or removal of other non-H₂S contaminants.

Within chamber 1012, streams 1141 and 1228 provide additional polishing as well as sulfur and level control among subchambers 1014, 1016, 1018. Stream 1228 branches from the portion of tertiary stream 1227 which contains newly regenerated or available reactant 165 that is provided to subchamber 1014. Stream 1141 provides additional available reactant 165 to subchamber 1018 via inlet 1068. The injection of the newly regenerated and available reactant 165 into subchambers 1014 and 1018 provides a greater concentration of available reactant to subchambers 1014, 1016, 1018 for contact with the H₂S in each of the effluents of eductors 1050, 1040, 1030 as well as within subchambers 1014, 1016, 1018. Further, the flow of streams 1141 and 1228 into chamber 1012 assists with the movement of the solid sulfur out of chamber 1012 rather than the sulfur collecting in chamber 1012.

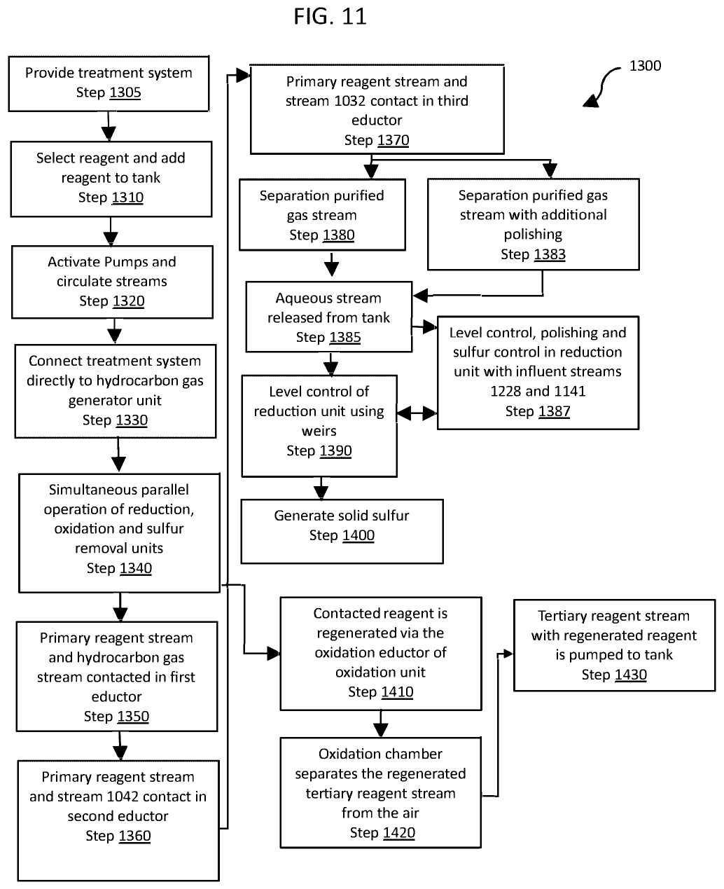

FIG. 11 depicts a flowchart of method 1300 of generating purified or treated hydrocarbon gas and/or elemental sulfur according to this disclosure. In step 1305, the desired treatment system 1200 or 2200 as discussed above and depicted in FIG. 9 or 10 may selected and provided. The selection of the particular treatment system 1200, 2200 may be based on characteristics of the influent gas stream 1210 such as the concentration of H₂S, CO₂, O₂, volumetric flow rate, and pressure.

In step 1310, the primary reagent stream 1220 may be initiated by placing the primary reagent stream 1220 including the reducing or redox reagent 165 to tank 1120. The tank 1120 should be filled such that the volume of primary reagent stream 1220 added to the tank 1120 is greater than the volume of reagent moving throughout the selected system 1200, including the reduction unit 1010, oxidation unit 1160, and sulfur separation unit 1270, at any point in time. Also, liquid level should be established in chamber 1012 to submerge downcomers 70. Further, if system 2200 is selected the liquid level 1103 of tank 1120 should be established above the slotted end 1102 of downcomer 1101. As discussed above, the concentration of iron or metal chelate in the primary stream 1220 in tank 1120 may be in the range of 4,000 mg/l to 20,000 mg/l.

In step 1320, depending on the selected system 1200, 2200, pumps 1130, 1137, 1256 and 1142 may be activated to provide the primary reagent stream 1220 to the reduction unit 1010 as well as the secondary and tertiary reagent streams 1223, 1227 to the respective sulfur removal unit 1270 and oxidation unit 1160. Pump 1141 is only activated if system 2200 is selected. Initially, pump 1130 may be initiated followed by pumps 1137, 1256. Once all the pumps 1130, 1137, 1256, as well as 1141, if applicable, of the provided system 1200, 2200 are active, system 1200, 2200 is prepared for simultaneous, continual operation of the reduction unit 1150, oxidation unit 1160 and sulfur removal unit 1270.

In step 1330, influent hydrocarbon gas stream 1210 (i.e., biogas stream) is directly connected to the system 1200, 2200 at inlet 1053 of the first eductor 50 of the reduction unit 1010. For example, one end of stream 1210 may be connected directly to inlet 1053 while the other end of stream 1210 is directly connected to the hydrocarbon gas generating unit 5 (i.e., bio generator or anaerobic digester).

In step 1340, now that the influent gas stream 1210 is being received by the reduction unit 1010 and all pumps 1130, 1137, 1256 are activated the selected system 1200, 2200 is continually generating purified or treated gas stream 1140 as well as regenerating the reagent 165 via the oxidation unit 1160 and removing the elemental sulfur from stream 1220 via the sulfur removal unit 1270.

As the secondary and tertiary reagent streams 1223, 1227 branch from the primary reagent stream 1220, these streams 1223, 1277 represent only a fraction of the reagent 165 that is contacted with the influent gas stream 1210 in the reduction unit 1010. As a result, only a fraction of the entire primary reagent stream 1220 may be regenerated in the oxidation unit 1160. Similarly, another fraction of the elemental sulfur generated in reduction unit 1010 may be simultaneously removed via sulfur removal unit 1270.

In step 1350, the hydrocarbon gas stream 1210 is contacted with the primary reagent stream 1220. Initially, the gas stream 1210 is entrained into the first eductor 1050 of the reduction unit 1010 by the pumping of stream 1220, via pump 1130, through inlet 1053 of first eductor 1050. Within the first eductor 1050, stream 1220 contacts gas stream 1210 and first eductor outlet stream 1091 is generated. The outlet stream 1091 travels through downcomer 1090 into subchamber 1014, and the discharge of stream 1091 which may include a slurry of elemental sulfur, gas, contacted and noncontacted reagent 165.

In step 1360, pump 1130 provides motive force to the primary stream 1220 flowing through the second eductor 1040, as a result, the second eductor drafts the contents of chamber 1012 or more specifically the contents of subchamber 1014 as stream 1042 into the second eductor 1040. Once inside eductor 1040, the primary stream 220 contacts stream 1042 and further reduces the concentration of H₂S within the gas of stream 1042. The second eductor 1040 discharges stream 1081 into subchamber 1016 via downcomer 1080. Stream 1081 may include a slurry of elemental sulfur, gas, contacted and noncontacted or available reagent 165. It is noted that stream 1081 may include a lower concentration of H₂S than stream 1091.

In step 1370, pump 1130 again provides motive force to the primary stream 1220 flowing through the third eductor 1030, as a result, the third eductor 1030 drafts the contents of subchamber 1016 as stream 1032 into the third eductor 1030. Once inside the third eductor 1030, the primary reagent stream 1220 contacts stream 1032 and further reduces the concentration of H₂S within the gas of stream 1032. The third eductor 1030 discharges stream 1071 into subchamber 1018 via downcomer 1090. Stream 1071 may include a slurry of elemental sulfur, gas, contacted and noncontacted reagent 165. It is noted that stream 1071 may include a lower concentration of H₂S than stream 1081.

In step 1380, purified gas stream 1140 is separated from the primary stream 1220. The method varies based on the selected system 1200, 2200. Initially, a slotted downcomer 1070 is utilized to direct stream 1071 into subchamber 1018. The use of the slotted end 1072 of the downcomer 1070 aids in the dispersion of the gas contained in 1071 under the liquid level 1111 (FIG. 10) of chamber 1012. Next, reduction unit 1010 allows the gas to separate from the primary stream 1220 and releases the purified or treated gas stream 1230 via outlet 1061 and the primary stream 1240 is released, via outlet 1060. Gas stream 1230 is released to tank 1120 which allows for further separation of the gas from the primary stream 1220 and purified gas stream 1140 may be conveyed for power generation or further treatment as desired.

Step 1383 is performed, when system 2200 is selected and includes providing additional polishing of gas stream 1230. A slotted downcomer 1101 conveys gas stream 1230 into tank 1120. The slotted end 1102 allows for the gas to bubble through the portion of the oxidized stream 1227 in tank 1120 that is above the slots. Finally, purified gas stream 1140 may be conveyed for power generation or further treatment as desired.

In step 1385, aqueous stream 1240, which has been separated from the treated gas stream 1230 and includes elemental sulfur as well as contacted and available reagent 165 leaves chamber 1012 via outlet 1060 and is conveyed to the next location in the selected system 1200, 2200. In system 1200, stream 1240 enters tank 1120 via inlet 1062. However, in system 2200, stream 1240 is conveyed to pump 1220 for distribution as primary stream 1220 to the oxidation unit 1160, reduction unit 1010 and sulfur removal unit 1270.

Step 1387 includes providing level control, additional polishing, and assistance for sulfur level control in reduction unit 1010. This step may be performed when system 2200 is selected and includes two additional influent streams 1228 and 1141 to reduction unit 1010. Pump 1142 receives stream 1141 from tank 1120 via outlet 1067. Next, pump 1142 transmits stream 1141 to subchamber 1018, via inlet 1068. Additionally, pump 1137 of the oxidation unit 1160 directs recently regenerated stream 1228 to subchamber 1014 via inlet 1093.

In step 1390, the level 1111 of fluid contained in chamber 1012 in the reduction unit 1010 is maintained through flow under weirs 1100 and 1110 as superimposed draft pressure from eductor 1050, 1040, & 1030 cause differential pressures between subchambers 1014, 1016, and 1018. Also, the perforations 1112 in weir 1110 allow volumes from subchamber 1016 to backflow into subchamber 1014 in a low net flow scenario, diminishing the draft across eductor 1040. These designs in tandem establish more stability in liquid level control and subsequently consistent gas treating. If system 2200 is selected, streams 1141 and 1228 also aid in equalizing the level within chamber 1012.

Step 1400 includes generating an elemental/solid sulfur stream 1254 by passing the tertiary stream 1223 through a sulfur removal unit 1270, which is described above. Further, solid/elemental sulfur stream 1254 is removed from system 1200, 2200 and a desulfurized tertiary stream 1223 is returned to tank 1120 via inlet 1063.

In step 1410, the reagent 165 within the tertiary stream 1227 is regenerated through an oxidation process occurring in oxidation unit 1160. Pump 1130 places a motive force on the tertiary reagent stream 1227 to draft the oxidizing stream 1135 into the oxidation eductor 1131 wherein the oxidizing stream 1135 and tertiary stream 1227 are contacted. In this example, the oxidizing agent in stream 1135 is atmospheric air drafted via vent 1132, but another oxidizing agent such as oxygen may be utilized.

In step 1420, oxidation tank 1136 receives the discharge of the oxidation eductor 1131 and separates the discharge into air and tertiary reagent stream 1227 which includes the regenerated reagent 165. Any excess air is released to the atmosphere via vent 1138 in tank 1136.

In step 1430, the tertiary stream 227 with regenerated reagent 165 is returned to tank 1120.

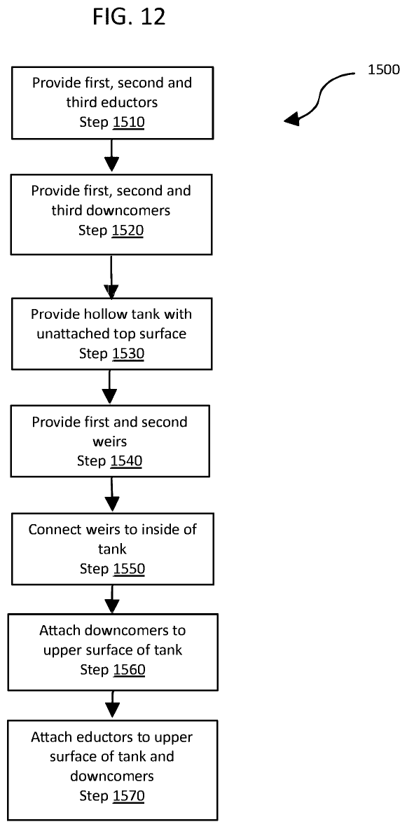

FIG. 12 depicts an embodiment, according to this disclosure, of a method 1500 of making a reduction unit 1010 for removal of H₂S from an influent gas stream. Initially, step 1510 includes providing the first, second and third eductors 1050, 1040 and 1030.

In step 1520, first, second and third downcomers 1090, 1080 and 1070 are provided. The third downcomer 1070 is provided with a greater length than the first and second downcomers 1090, 1980. Further, the third downcomer 1070 includes a slotted end 1072. Each downcomer 1090, 1080. 1070 should include widths equal to or greater than the width of the corresponding eductor 1050, 1040, 1030 so as to efficiently transfer the corresponding stream 1091, 1081, 1071 into chamber 1012.

Step 1530 includes providing hollow chamber 1012 as discussed above and shown in FIG. 5. Chamber 1012 may have a pentagon cross section as depicted in FIG. 5. However, other shapes are possible including rectangular, oval, and cylindrical. Further, sidewall 1020 reinforcement beams 1002, 1004, 1006 may also be placed on the interior and/or exterior of chamber 1012. A portion of the tank such as the top sidewall 1022 should remain removed from chamber 1012.

Step 1540 involves providing first and second weirs 1100, 1110 as discussed above. The provided weirs 1100, 1110 include recesses 1104 and weir 1110 includes perforations 1112. The recesses 1104 may be of different shapes as long as the weirs 1100, 1110 allow for flow beneath the weirs 1100, 1110. Further, the weirs 1100, 1110 should include a width equivalent to the inside distance between rear sidewall 1029 and front sidewall 1024 and equivalent to the length of line c shown in FIG. 6. This will allow the weirs 1100, 1110 to abut the rear sidewall 1029 and front sidewall 1024 of chamber 1012.

It is noted that the provided weirs 1100, 1110, chamber 1012 and downcomers 1090, 1080, 1070 may all be formed of various materials including stainless steel 304 and/or 316L, coated carbon steel, fiberglass, plastic and/or PVC, etc. In the case of stainless steel, sheets may be formed into the desired forms using methods known in the art.

In step 1550, weirs 1100, 1110 are installed in chamber 1012. The weirs 1100, 1110 may be placed within the tank such that first weir 1100 is connected to rear sidewall 1029, front sidewall 1024 and upper sidewall 1022 between eductor nozzle outlets 1035 and 1045 and the second weir 1110 connected to sidewall 1029, front sidewall 1024 and upper sidewall 1022 between inlets 1044 and 1054. The connection of the weirs 1100, 1110 to sidewall 1029, front sidewall 1024 and upper sidewall 1022 may be made via methods such as welding and bolts.

In step 1560, the first, second and third downcomers 1090, 1080, 1070 are attached to the upper sidewall 1022 of chamber 1012 such that they surround the respective outlets 1055, 1045, 1035 and extending into the interior of chamber 1012. Each may be designed as inserts to be removable. This attachment may be made as shown with bolt holes to fasten in place. Alternatively, the downcomers 1090, 1080, 1070 may be permanently attached via welding, etc.

In step 1570, the upper sidewall 1022 is connected to chamber 1012 with the downcomers 1090, 1080, 1070 extending into the interior of the chamber 1012 with weir 1100 between downcomers 1090, 1080 and weir 1110 between downcomers 1080 and 1070. The attachment of the upper sidewall 1022 to front sidewall 1024, and sidewalls 1026, 1027, 1029 may be accomplished through welding or bolts, etc.

After the influent gas has been treated by reduction unit 1010, if additional polishing for removal of H₂S is desired, polishing may be performed in tank 1120 of system 2200.

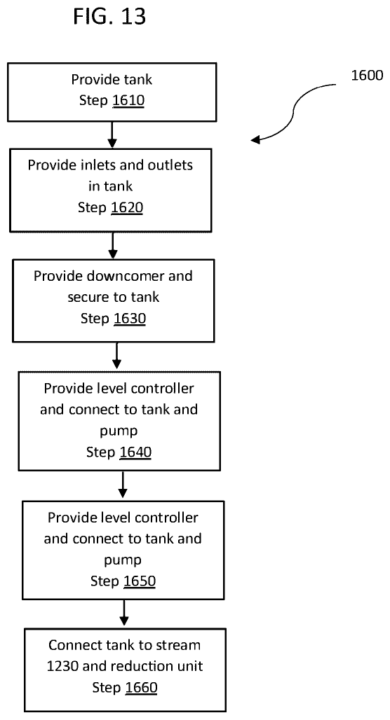

FIG. 13 depicts method 1600 of making tank 1120 for polishing as in system 2200. In step 1610, an enclosed hollow tank 1120 is provided with an inner chamber large enough to hold enough aqueous primary stream 1220 to circulate throughout system 2200. Tank 1120 may be formed of one-piece construction with a hollow chamber therein or the tank 1120 may be formed in multiple pieces such as with a lid and tubular section.

Next, in step 1620 purified gas stream 1140 outlet 1065, aqueous stream 1141 outlet 1067 and aqueous stream 1223 inlet 1063 are provided in tank 1120.

In step 1630, downcomer 1101 is provided and secured to tank 1120. The downcomer 1101 should be formed or selected based on factors such as required level of polishing and desired height or type of bubbling of the gas stream 1230 required to remove additional or even trace levels of H₂S from stream 1230. That is the dimensions and types of slots in the slotted end 1102 should be formed appropriately. Next, an opening corresponding to the width of the downcomer is formed in tank 1120 and downcomer 1101 is secured to tank 1120 such that the slotted end 1102 extends into tank 1120.

In step 1640, a level controller 1005 operably connected to tank 1120 and pump 1142. The level controller 1005 should be installed such that it maintains a fluid level 1003 at a suitable height above the slots in the downcomer 1001 and does not allow tank 1120 to become overfull or result in a high pressure drop. That is, the level controller 1005 monitors the fluid level 1003 to maintain the appropriate fluid level 1003 in tank 1120.

In step 1650, pump 1142 may be provided and connected to tank 1120, reduction unit 1010 and level controller 1005. Pump 1142 may be a centrifugal or vertical pump or any other suitable pump and may be positioned downstream of tank 1120 and upstream of reduction unit 1010. Stream 1141 is connected to pump 1142 such that pump 1142 receives stream 1141 from tank 1120 and moves stream 1141 into subchamber 1018 via inlet 1068.

In step 1660, tank 1120 is connected to the reduction unit 1010 via gas stream 1230. Stream 1230 leaves subchamber 1018 via outlet 1061 and is connected to downcomer 1101 which is configured to serve as a gas inlet for stream 1230 into tank 1120.

It is noted that the provided tank 1120 and downcomer 1001 may all be formed of various materials including stainless steel 304 and/or 316L, coated carbon steel, fiberglass, plastic and/or PVC, etc. In the case of stainless steel, sheets may be formed into the desired forms using methods known in the art.

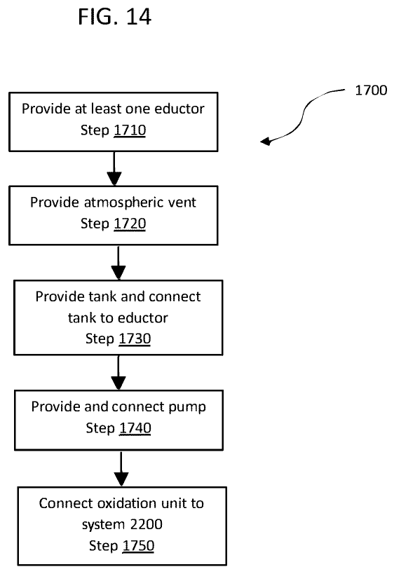

FIG. 14 depicts method 1700 of making the oxidation unit 1160, according to this disclosure, as discussed with respect to the embodiments depicted in FIGS. 9 and 10. Initially, in step 1710, at least one suitable eductor 1131 is provided. Eductor 1131 includes an opening 11 to receive the motive fluid stream 1227 and an opening 18 to receive an oxidizing stream 1135 which in this example is atmospheric air. It is noted that oxidation unit 1160 may be operated with one or more eductors 1131.

In step 1720, vent 1132 is provided and connected to the opening 18 via stream 1135. A suitable vent 1132 would be any ventilation device with a protective screen so as to protect eductor 1131 from taking in debris.

In step 1730, oxidation tank 1136 is provided and connected to the eductor outlet 14. The connection may be made through methods known in the art such as welding or bolting, etc. The tank 1136 includes a hollow chamber with an opening connection of eductor outlet 14 and another opening for connection of pump 1137. Also, the tank 1136 may be formed of various materials including stainless steel 304 and/or 316L, coated carbon steel, fiberglass, plastic and/or PVC, etc. In the case of stainless steel, sheets may be formed into the desired forms using methods known in the art.

In step 1740, pump 1137 is provided and connected to tank 1136 such that pump 1137 withdrawals the regenerated tertiary stream 1227 from tank 1136. A suitable pump may be vertical or centrifugal, etc. with enough force to pump the regenerated tertiary streams 1227, 1228 to tank 1120 and reduction unit 1010.

In step 1750, oxidation unit 1160 is connected to system 2200. Stream 1227 is connected between stream 1220 downstream of pump 1130. Stream 1227 is connected to tank 1120 and pump 1137. Also, stream 1228 is provided branching from stream 1227, and stream 1228 is connected to subchamber 1014 of reduction unit 1010.

It is noted that method 1700 includes stream 1228 which is included in the embodiment of FIG. 10 and system 2200. As stream 1228 is not included in FIG. 9, stream 1228 is an optional feature utilized for the benefits discussed above.

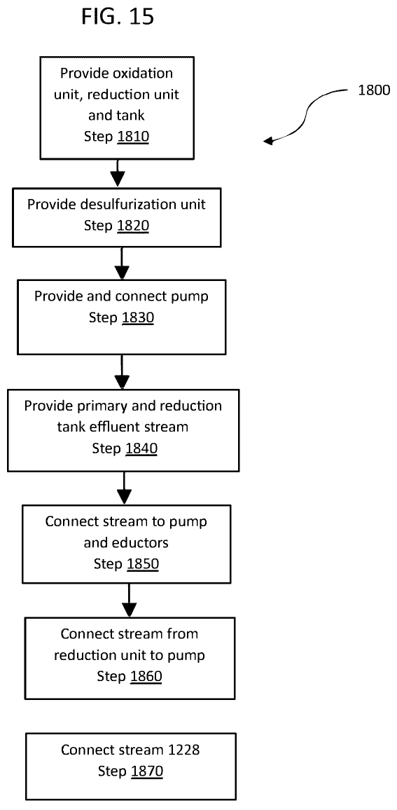

FIG. 15 depicts a method 1800, according to this disclosure, of constructing the system depicted in FIG. 10. Initially, in step 1810, the reduction unit 1010, tank 1120, and oxidation unit 1270 may be provided according to methods 1500, 1600, and 1700, respectively.

In step 1820, the desulfurization unit 1270 may be provided as discussed above.

In step 1830, pump 1130 (e.g., centrifugal or vertical) is provided. As pump 1130 provides the motive force for the reduction eductors 1050, 1040, 1030, oxidation eductor 1131 and propels secondary stream 1223 to the desulfurization unit 1270, pump 1130 must be sized appropriately.

Step 1840 includes providing reduction tank effluent stream 1240 and primary stream 1220.

Step 1850 includes connecting stream 1220 to pump 1130 and each eductor 1050, 1050, 1030 in a parallel configuration. Also, stream 1220 is connected to secondary stream 1223 and tertiary stream 1227. It is noted that in the method of making the system depicted in FIG. 9, stream 1220 would be connected from tank 1120 to pump 1130 and from the pump 1130 to the eductors 1050, 1040, 1030.

Step 1860 includes connecting stream 1240 from outlet 1060 of reduction unit 1010 to the influent of the pump 1130. It is noted that if this method 1800 were applicable to the system of FIG. 9, pump 1130 would receive the primary stream from tank 1120 rather than be connected to the chamber 1012 so as to receive contacted primary stream 1240 directly from the chamber 1012.

In step 1870, stream 1228 is connected between oxidized tertiary stream 1227, via inlet 1093, of the reduction chamber 1012. Also, stream 1223 is connected between pump 1256 of the desulfurization unit 1270 and inlet 1063 of the reduction chamber 1012 such that stream 1223 is propelled from the desulfurization unit 1270 to subchamber 1018 of the reduction unit 1160.

It is noted that in the method of making the system 1200 depicted in FIG. 9, streams 1223 is connect to inlet 1064 such that stream 1223 is returned to the tank 1120. Further, stream 1228 is not incorporated into system 9, but can be if desired.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A gas treatment system comprising:
an eductor including a motive fluid inlet, a gas inlet and an eductor outlet, the motive fluid inlet connected to a primary stream including an aqueous metal chelant, the gas inlet configured to receive an influent gas stream, the eductor configured to contact the influent gas stream, including hydrogen sulfide and hydrocarbons, with the aqueous metal chelant and release, via the eductor outlet, an eductor effluent stream including a treated gas and the aqueous metal chelant;
a chamber connected to the eductor outlet, the chamber configured to receive the eductor effluent stream, the chamber including a sidewall defining a gas outlet separate from an aqueous outlet such that the chamber is configured to separate the treated gas from the aqueous metal chelant; and
the primary stream extending from the aqueous outlet of the chamber to the motive fluid inlet of the eductor such that the primary stream circulates aqueous metal chelant from the chamber to the eductor and pulls the influent gas stream into the eductor.

2. The system of claim 1, further comprising:
the eductor being a first eductor, the eductor effluent stream being a first eductor effluent stream, the eductor outlet being the first eductor outlet, and the motive fluid inlet being the first motive fluid inlet; and
a second eductor configured to contact a treated gas stream and the aqueous metal chelant and release a second eductor effluent stream including the treated gas and the aqueous metal chelant into the chamber, the second eductor including a second motive fluid inlet connected to the primary stream, a second eductor outlet connected to the chamber, and a second eductor inlet connected to the chamber such that the second eductor inlet withdraws the treated gas stream from the chamber.

3. The system of claim 2, further comprising:
at least one weir in the chamber, the at least one weir positioned between first and second eductors, the at least one weir configured to allow flow under the at least one weir; and
a first subchamber on one side of the at least one weir and a second subchamber on a second side of the at least one weir, the first and second subchambers in fluid communication by flow under the at least one weir.

4. The system of claim 3, wherein the at least one weir is between the first eductor outlet and the second eductor outlet.

5. The system of claim 3, further comprising:
a third eductor including a third motive fluid inlet connected to the primary stream, a third eductor outlet connected to the chamber and a third eductor inlet connected to the chamber such that the third eductor inlet withdraws a treated gas stream from the second eductor subchamber;
a second weir in the chamber, the second weir positioned between second and third eductors, the second weir configured to allow flow under the second weir; and
a third subchamber between the second weir and a sidewall of the chamber and the second subchamber between the at least one weir and the second weir, the first, second and third subchambers in fluid communication by flow under the first and second weirs, the gas outlet being in the third subchamber.

6. The system of claim 3, further comprising:
a downcomer attached to the second eductor outlet, the downcomer extending into the second subchamber of the chamber.

7. The system of claim 5, further comprising:
a downcomer attached to the third eductor outlet, the downcomer extending into the third subchamber of the chamber.

8. The system of claim 5, wherein the at least one weir and the second weir include a recess in a lower edge under which the at least one weir allows fluid flow.

9. The system of claim 1, wherein the aqueous metal chelant further comprises:
a metal chelant, metal chelants, ferric salts, ferrous salts, ferric chelants, ferrous chelants, nano-iron, colloidal iron, Fe-MGDA, HEME, organisms containing HEME, or a combination thereof.

10. The system of claim 1, further comprising:
a gas inlet in the eductor; and
a biogas stream connected to the gas inlet such that the influent gas stream is the biogas stream.

11. A method of treating an influent gas with an aqueous metal chelant, the method comprising:
receiving an influent gas stream including hydrocarbon gas and hydrogen sulfide;
using a first eductor including a first motive fluid inlet and a first eductor outlet, to contact the influent gas stream, with an aqueous metal chelant and release, via the eductor outlet, an eductor effluent stream including a treated gas and the aqueous metal chelant;
receiving, in a chamber connected to the eductor outlet, the eductor effluent stream; and
circulating the aqueous metal chelant from an aqueous outlet of the chamber to the motive fluid inlet of the eductor.

12. The method of claim 11, further comprising:
releasing a hydrocarbon gas from a gas outlet in the chamber.

13. The method of claim 11, further comprising:
separating, in the chamber, the treated gas from the aqueous metal chelant;
withdrawing, via a second eductor having a second eductor inlet connected to the chamber, the treated gas through the second eductor inlet from the chamber;
receiving, via a second motive fluid inlet of the second eductor, the aqueous metal chelant in the second eductor;
contacting in the second eductor the treated gas and the aqueous metal chelant; and
releasing a second eductor effluent stream from a second eductor outlet of the second eductor into the chamber.

14. The method of claim 13, further comprising:
allowing aqueous metal chelant in the chamber to flow under at least one weir in the chamber, then at least one weir positioned between the first and second eductors.

15. The method of claim 13, further comprising:
releasing the second eductor effluent stream into the chamber via a downcomer connected to the second eductor outlet and the downcomer extending into the chamber.

16. The method of claim 13, further comprising:
withdrawing, via a third eductor having a third eductor inlet connected to the chamber, the treated gas through the third eductor inlet from the chamber;
receiving, via a third motive fluid inlet of the third eductor, the aqueous metal chelant in the third eductor;
contacting in the third eductor the treated gas and the aqueous metal chelant; and
releasing a third eductor effluent stream from the third eductor into the chamber.

17. The method of claim 16, wherein releasing a third eductor effluent stream from the third eductor into the chamber further comprises:
releasing the third eductor effluent stream into the chamber via a downcomer connected to a third eductor outlet of the third eductor and the downcomer extending into the chamber.

18. The method of claim 16, further comprising:
allowing the aqueous metal chelant to flow under a second weir in the chamber, wherein the second weir is between the second and third eductors.

19. The method of claim 11, wherein the aqueous metal chelant further comprises:
a metal chelant, metal chelants, ferric salts, ferrous salts, ferric chelants, ferrous chelants, nano-iron, colloidal iron, Fe-MGDA, HEME, organisms containing HEME, or a combination thereof.

20. The method of claim 11, wherein of receiving an influent gas stream including hydrocarbon gas and hydrogen sulfide further comprises:
receiving biogas as the influent gas stream.

21. The method of claim 11, wherein receiving the influent gas stream including hydrocarbon gas and hydrogen sulfide further comprises receiving a hydrocarbon gas including CO₂.
